(19) United States
(12) Patent Application Publication
(10) Pub. No.: US 2006/0158336 A1
(43) Pub. Date: Jul. 20, 2006

(54) Home and home occupant remote monitoring and communication system

(76) Inventors: Illah Reza Nourbakhsh, Pittsburgh, PA (US); Ofer Matan, Seattle, WA (US)

Correspondence Address: Illah Nourbakhsh, 2529 Beechwood Blvd, Pittsburgh, PA, 15217, US

(21) Appl. No.: 11/323,754

(22) Filed: Jan. 3, 2006

Related U.S. Application Data
(60) Provisional application No. 60/640,855, filed on Jan. 3, 2005.

(51) Int. Cl. G08B 23/00; G08B 19/00; G08B 1/00

(52) U.S. Cl. 340/573.1; 340/531; 340/521

(57) ABSTRACT

A system for home and home occupant monitoring that requires near-zero set-up time and set-up expertise, and provides for both authentication, security and semantically meaningful interpretation of home activity.

### CROSS-REFERENCE TO RELATED APPLICATIONS

This is a non-provisional of the provisional U.S. Application 60/640,855, filed Jan. 3, 2005.

### STATEMENT REGARDING FEDERALLY SPONSORED RESEARCH OR DEVELOPMENT

Not Applicable.

### BACKGROUND OF THE INVENTION

This invention relates to the need for individuals to ascertain the vital status (e.g. health, safety, security, activity, behavior trends, etc.) of people and places that are physically removed from the individual. Specifically, this invention comprises a networked solution to enable improved home monitoring/security as well as home occupant monitoring. The latter is of increasing significance because of demographic trends throughout the U.S. and the first world that foreshadow increasing numbers of elderly home occupants, cared for by a proportionally diminishing number of caregivers. To enable individuals to check on, for instance, home-bound elderly parents and their home environment demands a networked communication infrastructure with a number of critical features:
(1) Ease of Installation. Because the network must be installable and functional in homes with widely varying levels of technological infrastructure and occupant technical knowledge, the system as a whole must be both maximally easy to install and operate without technical knowledge, and must simultaneously guarantee that the installation process does not cause security lapses (e.g. connection of data streams to networks in nearby homes). Note that ease of use is in and of itself of paramount importance; if the system is difficult to install in a home then the market will shrink enormously. One important criteria used to motivate a preferred embodiment of this invention is that the system should be installed, out of the box, in the target home simply by removing the units from the shipping boxes and plugging them into AC outlets, just as with desk lamps—requiring no further local steps to arrive at a basic level of functionality. No multi-purpose personal computer should be required for installation of the system nor for operation of the system nor for diagnosis of system problems.
(2) Comprehensible Data Service. The amount of information that can be collected for a home occupant is enormous, including video (e.g. real-time, cached), images, audio and a variety of exogenous sensors such as motion, light, temperature and air quality. It is critical that mathematical and statistical techniques as well as machine vision algorithms be used altogether in order to enable the system to recognize and flag out-of-nominal conditions. The in the preferred embodiment described below the system “adapts” to the specific spatio-temporal habits of the home's occupant(s), thereafter noting and reporting discrepancies between expected interpreted sensor values and actual, read values.
(3) Security. Because private information pertaining to home and home occupants will be transmitted over such a network, including audio, digital readings and video, it is critical that the invention achieve a high level of internal security so that the data will be available only to authorized “viewers.”
(4) Ease of Secure Extensibility. Because such a home and occupant monitoring system will be dynamic and not static, both in composition and location, it is important that such modification and extension be simple enough for a non-technical occupant while simultaneously guaranteeing security during and following such system modifications.
(5) Ease of Communication/Connection. The central purpose of this invention is to bring together a remote user (i.e. a responsible party) and multimedia information local to a home and its occupants. As such a critical need is that the system deliver easy methods for the remote user to access the home network and its data from as many possible input/output devices and locales as possible.
(6) Ease of Maintenance. The reliability of this system is of paramount importance to its acceptance, and so maintenance of the system and repairs to the system must be effected in as facile a manner as possible, both by the responsible remote user(s) and by the local occupants that may have very little technical knowledge.

### BRIEF DESCRIPTION OF THE DRAWING

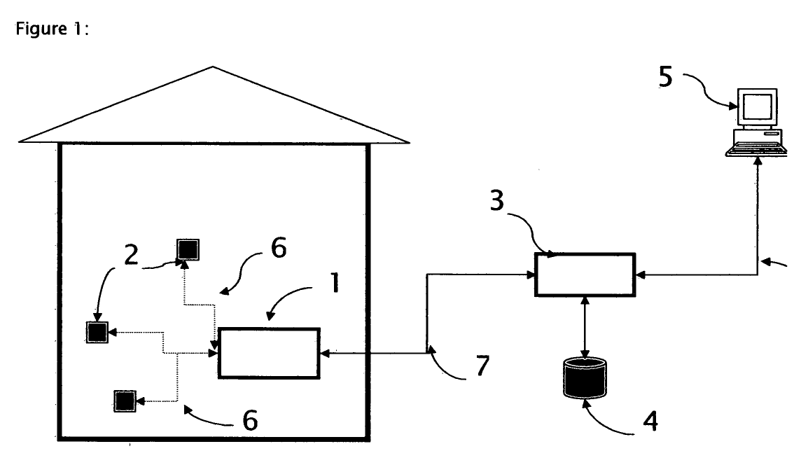

This invention presents a solution to the problem of home and home occupant remote monitoring and communication while achieving all of the needs identified above, as described below. In order to aid in understanding this invention refer to FIG. 1. The in-home central server 1 serves as a bidirectional communication device both with respect to the in-home local network (which can be wireless) 6 and with respect to the private network connecting the central server to a secure out-of-home data routing 7. Within the home one or more devices 2 may be attached to the in-home network 6 to communicate with the overall system. A secure bridge 3 provides out-of-home transition of data bidirectionally between a secure network 7 with direct access to in-home servers 1 and the public network 8 that enables maximal connectivity for system users. A secure data store 4 retains key information in enabling routing between public and private networks, including configuration parameters, passwords and other needed data products to ensure reliable, safe and easy-to-use public connections to the system. Any computing device 5, from a desktop computer or laptop to a PDA or cellular telephone may serve as the input/output device for the system user to access the information stream all the way to the intra-home network 6 and all of its nodes 2 and server 1.

### DETAILED DESCRIPTION OF THE PREFERRED EMBODIMENT

Two subsystems comprise the complete home and home occupant communication system that achieves the desirable features introduced above: first, the communication infrastructure, architecture and system attributes related to intra-home data handling and interaction; and second, the communication infrastructure, architecture and system attributes related to interaction and handling of home data outside the home. Each subsystem's qualities in this solution, as well as embodiments of each, are described below.

The system must enable robust and secure intra-home communication between a multitude of devices that comprise the intra-home network. At the same time the system must have a gateway to enable data flow out of the home. To this end the intra-home architecture of this invention is heterogeneous and centralized, with one central server that acts as a secure router out of the home and that acts as the network authority for the devices inside the home. In one embodiment of this invention the central server contains a cellular transceiver and local wireless radio, enabling communication out of the home via cellular data transmission and local networking using digital wireless data transmission such as 802.11 g. In another embodiment of this invention the central server contains cable modem or DSL hard-wire hookup and employs high-frequency data transmission via power mains (e.g. ×10 protocol) for data communication within the home. In a preferred embodiment the central server is an embedded computing device, employing low-power and reliable processors. In such a preferred embodiment no portion of the in-home system requires the existence and proper functioning of an all-purpose home computer.

Device sensors envisioned by this invention, but by no means limiting the set of such devices, include video, still images, imagery under pan/tilt control, imagery making using of catadioptric views, infrared detection of body heat and motion, pyroelectric sensor-based detection of human motion, environmental temperature, environmental carbon monoxide levels, voice recognition and understanding, bi-directional audio and wearable body sensing devices.

In addition, raw sensor data including visible light video, infrared and other forms of data will be interpreted by computer vision algorithms and mathematical/statistical algorithms, including motion detection, shape detection, human body pose detection, face detection and scene understanding in order to develop higher-level, semantically meaningful interpretations of in-home activities and occupants' status. Note that the architecture described in this invention enables such perceptual analysis algorithms to be resident locally, at the device; locally, at the central server; or remotely, within the off-home network. Such interpretation of local sensory data to yield semantically meaningful information regarding occupant activity as well as trajectories of expected activity patterns is a critical ingredient of the present invention. Techniques from the fields of Artificial Intelligence, Machine Learning and Statistics form the backbone of this effort in converting raw data to human-comprehensible conclusions regarding behavior normalcy.

It is important to enable dynamic network reconfiguration, including but not limited to addition/removal of individual home devices, moving the physical location of home devices or the central server, or complete transferal of the entire system to a new home. The intra-home configuration of this invention, coupled with optional data stored at a secure off-home site, yields a secure dynamic network. Specifically, an intra-home network monitors the communication status of each in-home device on the network. This monitoring operation is performed locally at the home's central server. Each in-home central server and each additional device has a globally unique identifier. Information regarding unique device identifiers associated with each home central server is stored both at that central server and, via a data link to a secure outside data store, at an off-home site. Removal of any device is detected at the home's central server, and causes an update of both local files and off-home files, be they distributed or centralized. Addition of new in-home devices, or large-scale moving of the entire system or sub-collection of devices, requires the operation of an authentication step to ensure that the device-central server relationship established is correct.

This authentication is critical to avoiding both accidental network bridging between one home's central server and an adjacent home's new device, and is also critical to avoiding deliberate network theft (i.e. “piggybacking”) using an adjacent home's central server. The present invention authenticates using a tertiary information source. In one real-time embodiment, this invention allows an occupant of the home to add a device with authentication by proving physical proximity of the device to the home's central service, for instance via bar-code reading of the device's unique identifier or an RFID-based short-range ID communication protocol. In another real-time embodiment, the occupant may add the device by powering up the device and simultaneously using an input device to inform the central server that a new device is being added at precisely that point in time, thus achieving authentication through temporal triggering. In one non-real-time embodiment, this invention allows a remote system user to authenticate addition of a device by registering, for instance via a secure web page, the unique identifier of a device intended for a specific home's network. In this case data communication from off-home to the home's central server would provide information regarding the expected device's identifier.

A further requisite feature involves the proper functioning of the in-home infrastructure both during power loss and following resumption of AC power supply. In the case of power loss, backup power supplies in the form of alternate energy supplies or storage can enable complete or partial operation to continue. This is of particular value when the gateway technology for data communication between the in-home central server and the off-home network consists of a mode not dependent on AC power; for example, cellular, telephone modem, telephone ADSL, cable modem, etc. In the case of a lack of power supply backup, it is important that proper operation of the overall communication system resume when AC supply is restored. This invention ensures successful reboot properties through the use of memory stores on the in-home central server that are persistent in the face of power loss. In one embodiment this memory store consists of EEPROM; in another embodiment this memory store consists of Flash. In each case the memory store captures configuration data, consisting minimally of the unique identifiers of all devices comprising the in-home network.

Because the in-home network's bandwidth to the off-home network may be variable across multiple installations and, in fact, variable over time even in a single installation, this invention also prescribes local caching of device data at nodes within the in-home network. For instance, an imaging device's data may be cached locally at the central server during bursts of activity, enabling metered communication of that data from the central server using a telephone modem connection to the off-home network.

An important secondary feature of the in-home network is to provide computational services, focused at the central server, for interpretation and reaction to device values over time. Specifically, we propose that the in-home central server perform statistical evaluation of device values over the life of the network, providing temporally indexed, learned models of expected device measurements and, consequently, the ability to identify out-of-expectation device readings. Note that such statistical analyses may be combined with higher-level perceptual interpretation, as described earlier. The system may be configured to provide alerts at varying levels of escalation. Such configuration for alerts may be performed remotely using, for example, web-based interface. Such configuration may also be performed in-home, locally, using simple interface devices resident to the central server or associated I/O devices within the home.

Another important secondary feature of the in-home network, specifically when combined with the extra-home interface and infrastructure, is the ability to limit visualization through a number of means in order to achieve modesty in the appropriate contexts and during the appropriate activities, e.g. when an occupant is changing clothes or using the restroom. Specific visual limitations include infrared-only imaging, tessellation of images with high pixelation levels, color saturation control, Gaussian smoothing, etc. Such visualization metamorphoses are combined with contextual awareness or input devices enabling, for instance, the home occupants to identify compromising views and times.

The extra-home portion of the remote home and home occupant monitoring system is responsible for providing a bridge between the secure two-way transmission of data to each home's central server and the transmission of data using a multitude of public network routes to the remote system user or users. Configuration information, including the unique identifiers comprising the collection of devices and the central server resident at each home, is mirrored on individual central servers and also on database elements resident outside of all in-home central servers, at a secure location accessible via the primary communication route available to home central servers.

In order to provide portal services reaching each home central server, the extra-home infrastructure provides routing functionality from a central server's secure communication channel (e.g. cellular, ADSL, cable modem, AC power mains) to multi-media devices available to remote users as input/output devices, including cellular telephones, personal digital assistants, laptop computers, internet cafes, public network access points, etc. This portaling must guarantee security, and in this invention security depends minimally upon password protection, and in cases where greater security is sought this is provided through encryption, dynamic password protection, IP address gating, and other secure login and data protection means commonly available for modern computer security.

While customized interfaces are provided for each remote inputs/output device form factor, the functionality demanded of each such interface includes:
(1) Payment: the ability to remotely pay for service startup or continuation
(2) Alarms: the ability to configure, receive and respond to alarm notifications
(3) Verification/Usage: the ability to access device data in user-friendly formats
(4) Communication: the ability to employ the invention as a real-time or non-real-time communication device to communication with home occupant(s).

One specific notable input/output interface is a telephone—network bridge. Specifically, the remote user may request, via the web portal or by dialing a special telephone number, that his/her cellular telephone or land-line be routed directly to an in-home unit for audio reception and transmission, much like a telephone-to-speakerphone network using “voice over IP” bridged with traditional telephony networking.

The extra-home and in-home networks together also provide a further level of functionality: remote technical support and troubleshooting. By providing remote technical support personnel with access to configuration parameters and other internal parameters of the in-home network, including both the central server and the home's associated devices, that technical support staff may, in real time and in non-real-time, provide guidance and aid in correcting or improving system qualities as desired by home occupants or remote users.

A number of strategies will be used for sale of the remote home and home occupant monitoring system invention. Unit sales enable low entry cost via small-unit system sales, followed by opportunities to grow an in-home network in terms of spatial coverage, sensory richness and perceptual richness through the acquisition and addition of incremental units to the existing in-home system. A monthly subscription fee enables ongoing revenue to be generated from ever-larger numbers of subscribers, while unlimited volume of use, coupled with caching and with interface design that enforces practical limits on bandwidth demands, will lead to greater user satisfaction.

Business partners, co-branding opportunities and licensing potentials include cellular telephone companies, due to the potential of this invention for growing the market of cellular data communications activities well beyond the current web-based PDA model. Additional co-branding opportunities include lamps, telephones and other existing in-home products. Finally, development opportunities with respect to building contractors can enable a home to be built or remodeled with infrastructure appropriate and tuned to this home and home occupant monitoring system already installed, further reducing installation time and increasing the potential for functionality.

What is claimed is:

1. A system for home and home occupant remote monitoring, the system comprising:
a centralized, heterogeneous in-home network including at least one in-home central server and one or more sensing devices;
at least one in-home device assigned the role of communication relay;
at least one outside-home private server and data repository;
communication between the in-home network and the outside-home private server and data repository via one or more communication relays;
communication between the outside-home private server and data repository and the public network, enabling authenticated access across the public network to in-home central server date, in-home sensing device data and outside-home private server data.

2. The system as described in claim 1, wherein in-home communication between the in-home central server and in-home sensing devices employs radio frequency communications protocols.

3. The system as described in claim 1, wherein communication between in-home communication relays and the outside-home private server employs cellular data protocols.

4. The system as described in claim 1, wherein addition of new in-home sensing devices requires authentication and the use of unique identifiers to ensure secure dynamic networking.

5. The system as described in claim 4, wherein authentication is performed spatially by sensing the position of a new in-home sensing device relative to the in-home central server.

6. The system as described in claim 4, wherein authentication is performed temporally by the user identifying the unique identifier of the sensing device in near simultaneity with powering on the new sensing device.

7. The system as described in claim 1, wherein persistent memory storage at the in-home central server retains network parameter and device identifier information to enable power-loss recovery.

8. The system as described in claim 1, wherein in-home data caching enables limited-bandwidth communication between the in-home network and the outside-home network.

9. The system as described in claim 1, wherein the outside-home server and data repository provides interpretations and statistical analyses of raw in-home sensing data, said interpretation and analyses being performed both by the in-home server and by the outside-home server.

10. The system as described in claim 1, wherein outside-home server access to internal parameters of the in-home network enables remote technical support.
